(19) United States
(12) Patent Application Publication
(10) Pub. No.: US 2008/0023599 A1
(43) Pub. Date: Jan. 31, 2008

(54) Video display

(75) Inventor: Shih-An Lin, Taipei County (TW)

Correspondence Address: BIRCH STEWART KOLASCH & BIRCH, PO BOX 747, FALLS CHURCH, VA, 22040-0747, US

(73) Assignee: BENQ Corporation

(21) Appl. No.: 11/878,405

(22) Filed: Jul. 24, 2007

(30) Foreign Application Priority Data
Jul. 25, 2006 (TW) 95127182

(51) Int. Cl. F16M 11/00

(52) U.S. Cl. 248/122.1; 248/125.8

(57) ABSTRACT

A video display comprises a display housing, a pivotal mechanism, a support arm pivotally supporting the display through the pivotal mechanism, and a engagement mechanism. The support arm further has a first lateral surface, a second lateral surface, an accommodation groove located at the lateral surface, and a first pivotal structure located inside the accommodation groove. The pivotal mechanism further provides a pivotal spacing formed between the display housing and the support arm. The engagement mechanism has a block portion at one end, an elastic means at another end and a second pivotal structure in the middle. The engagement mechanism is received within the accommodation groove with the second pivotal structure engaged pivotally with the first pivotal structure. In the case of locating the block portion outside the pivotal spacing, the display housing and the first lateral surface are at a contact state. In the case of locating the block portion inside the pivotal spacing, the display housing and the first lateral surface are at a separate state.

This application claims the benefit of Taiwan Patent Application Serial No. 95127182, filed Jul. 25, 2006, the subject matter of which is incorporated herein by reference.

### BACKGROUND OF THE INVENTION

(1) Field of the Invention

The invention relates to a video display, and more particularly to a flat video display whose pitch angle can be arbitrarily adjusted.

(2) Description of the Prior Art

Please refer to FIG. 1A, in which a conventional video display 10 is shown in an look-up angle. The video display 10, generally a liquid crystal display (LCD) panel, includes a display 11, a support arm 13 and a base 15. The display 11 is raised by the support arm 13, while the support arm 13 is extended upward from the base 15. The video display 10 can further include a pivotal mechanism 17 to join the display 11 and the support arm 13. Through the pivotal mechanism 17, pitch angles of the display 11 can be adjusted according to users' need.

As shown, the display 11 can have an angular work region α, which defines the angling limits of the display 11. Definitely, the magnitude of the angular work region α is highly related to the pivotal mechanism 17. To most of countries, the magnitude of angular work region α needs to meet their domestic safety regulations. The restriction on the angular work region α is usually to concern (1) if the display 11 can stand safely, and (2) if the user is comfortable while in using the video display 10.

As shown in FIG. 1A, a base line 18, preferably a vertical line, is introduced to define the angle 0 of the pitch angle. The display 11 would be at a look-up state if its pitch angle is positive as shown by an angle of elevation “+a”, and a look-down state if negative as shown by an angle of depression “−b”. According to European safety regulations, the angle of elevation for such a display 11 in usage should be larger than 20 degrees, while the angle of depression shouldn't be less than 5 degrees.

Nevertheless, it is also the expectation of both the users and the manufacturers that the video display 10 can have a minimum-volume storage state. Definitely, a storage state to have the display 11 flush with the support arm 13 is preferable. Referring now to FIG. 1B, the video display 10 of FIG. 1A is posed at a storage state having a storage angle β. The storage state of the video display 10 is prepared for package in a carton. Generally in the manufacturer, before the video display 10 to be packed, the base 15 is disassembled in advance from the support arm 13, and the support arm 13 is pivoted to be flush with the display 11; such that the required storage volume as well as the board thickness of the carton can be reduced to a minimum. It is noted and interesting that the storage angle β is usually beyond the scope of the allowable pitch angle, i.e. the angular work region α.

Referring now to FIG. 2A, the pivotal mechanism 17 for the video display of FIG. 1A is shown. The pivotal mechanism 17 includes a first pivotal plate 171, a second pivotal plate 172 and a first hinge 173 to swing the first pivotal plate 171 with respect to the second pivotal plate 172. Both the first pivotal plate 171 and the second pivotal plate 172 have built-in holes 175, in response to match holes (not shown in the figure) on the display 11 and the support arm 13, respectively. By applying some screws (not shown in the figure) to these corresponding holes, the first pivotal plate 171 and the second pivotal plate 172 can be fastened to the display 11 and the support arm 13, respectively. Upon such an arrangement of the pivotal mechanism 17, the display 11 can then be pivotal with respect to the support arm 13.

It is clear that the usage of the hinge 173 in the video display 10 can't tell the work angle α from the storage angle β. That is to say that the display 11 in usage is easy to be carelessly posed at angle within the range of β, beyond the allowable work region defined by α. Apparently, a work angle over the allowable pitch angle in applying the video display 10 is against the safety regulations, and is easy to make the panel 10 unbalance and fall during the usage.

Referring now to FIG. 2B, another pivotal mechanism 17 for the video display 10 of FIG. 1A is shown. In this structuring, the video display 10 includes a first pivotal plate 171, a second pivotal plate 172, a first hinge 173 and a second hinge 174. Except for the second hinge 174, the pivotal mechanism 17 of FIG. 2B is functional and structured as the same as that of FIG. 2A. Similarly to the first hinge 173, the second hinge 174 is also provided to join the first pivotal plate 171 and the second pivot plate 172. The difference between the first hinge 173 and the second hinge 174 are: (1) that the torque to turn the first hinge 173 is less than that to the second hinge 174; and (2) that angular work region of the first hinge 173 is different to that of the second hinge 174.

By applying the pivotal mechanism 17 of FIG. 2B, when the display 11 rotates within the allowable pitch angle α, the first hinge 173 is in action and the second hinge is just freely followed (not in action). Therefore, under such a circumstance, the toque to rotate the display 11 is almost the same as the torque applied at the first hinge 173. On the other hand, when the display 11 is rotated to be beyond the allowable pitch angle α (i.e. entering the region of the storage angle β), the second hinge 174 comes into action, and thus the toque to rotate the display 11 is distributed to turn both the first hinge 173 and the second hinge 174. In particular, if the partitioned torque on the second hinge 174 (from the torque applied to the display 11) cannot overcome a minimum torque to activate the second hinge 174, the display would stop at a position showing the maximum allowable angle of depression in the work region α.

Obviously, the pivotal mechanism 17 of FIG. 2B is superior to that of FIG. 2A, in safety consideration. However, the inclusion of the second hinge 17 costs more. Besides the cost, a careless torque applied to activate the second hinge 174 may also damage the second hinge 174 as well as the video display 10.

Accordingly, in consideration upon the cost, the storage, the safety regulations, the usage and the user torque application of the video display 10, an improvement of the pivotal mechanism upon the video display is definitely welcome to the skilled person in the art.

### SUMMARY OF THE INVENTION

Accordingly, it is an object of the present invention to provide a video display that can clearly distinguish the work region from the storage region while in tilting the display housing of the video display.

It is another object of the present invention to provide a video display that can restrict the display housing of the video display only within the work region while in adjusting the display housing at an angle of elevation. Thereby, the jeopardy of falling the video display can be avoided, and a well vision to the user can also be guaranteed.

In the present invention, the video display comprises a display housing, a support arm, a pivotal mechanism, a engagement mechanism and a base. The display housing is mounted to an upper end of the support arm, and the base for grounding the video display is mounted to a lower end of the support arm. The pivotal mechanism joining the support arm and the display housing is to pivot the display above the support arm. The support arm further includes a first lateral surface that provides a portion thereof at least to be tangible with respect to the display housing. In the case that the display housing is turned from a contact state to a separate state with respect to the first lateral surface, the engagement mechanism can be plugged into a pivotal spacing between the display housing and the first lateral surface so as to keep the display housing and the first lateral surface at the separate state.

In one embodiment of the present invention, the engagement mechanism of the video display can include a block portion at one end, an elastic means at another end, and a second pivotal hole in the middle of the engagement mechanism. The support arm can further include an accommodation groove and a first pivotal pin. The engagement mechanism is received within the accommodation groove, with the second pivotal hole engaged with the first pivotal pin, and with the elastic means contacting at the support arm. The engagement mechanism can send the block portion into the pivotal spacing by pivoting about the first pivotal pin so as to separate the display housing from the first lateral surface.

In one embodiment of the present invention, the engagement mechanism of the video display can include be formed as an elastic element having a block portion at one end and an engagement portion at another end. The engagement portion is to engage a position mechanism at a second lateral surface of the support arm. By bending the engagement mechanism, the block portion can be sent into the pivotal spacing so as to separate the display housing from the first lateral surface.

All these objects are achieved by the video display described below.

### BRIEF DESCRIPTION OF THE DRAWINGS

The present invention will now be specified with reference to its preferred embodiment illustrated in the drawings, in which:

FIG. 1A is a side view of a conventional video display;

FIG. 1B is a side view of the video display of FIG. 1A, posed at a storage angle β;

FIG. 2A is a perspective view of a conventional pivotal mechanism for the video display of FIG. 1A;

FIG. 2B is a perspective view of another conventional pivotal mechanism for the video display of FIG. 1A;

FIG. 3 is an exploded view of a preferred embodiment of the video display in accordance with the present invention;

FIG. 3A is an enlarged view of circle A of FIG. 3;

FIG. 4A is a perspective view of the video display of FIG. 3, posed at a contact state;

FIG. 4B is an enlarged view of circle B of FIG. 4A;

FIG. 4C is another perspective view of the video display of FIG. 3, posed at a separate state;

FIG. 4D is an enlarged view of circle C of FIG. 4C;

FIG. 5 is an exploded view of another embodiment of the video display in accordance with the present invention;

FIG. 5A is an enlarged view of circle D of FIG. 5;

FIG. 6 is an exploded view of a further embodiment of the video display in accordance with the present invention;

FIG. 6A is an enlarged view of circle E of FIG. 6;

FIG. 7A is a perspective view of the video display of FIG. 6, posed at a contact state;

FIG. 7B is an enlarged view of circle F of FIG. 7A;

FIG. 7C is another perspective view of the video display of FIG. 6, posed at a separate state; and

FIG. 7D is an enlarged view of circle G of FIG. 7C.

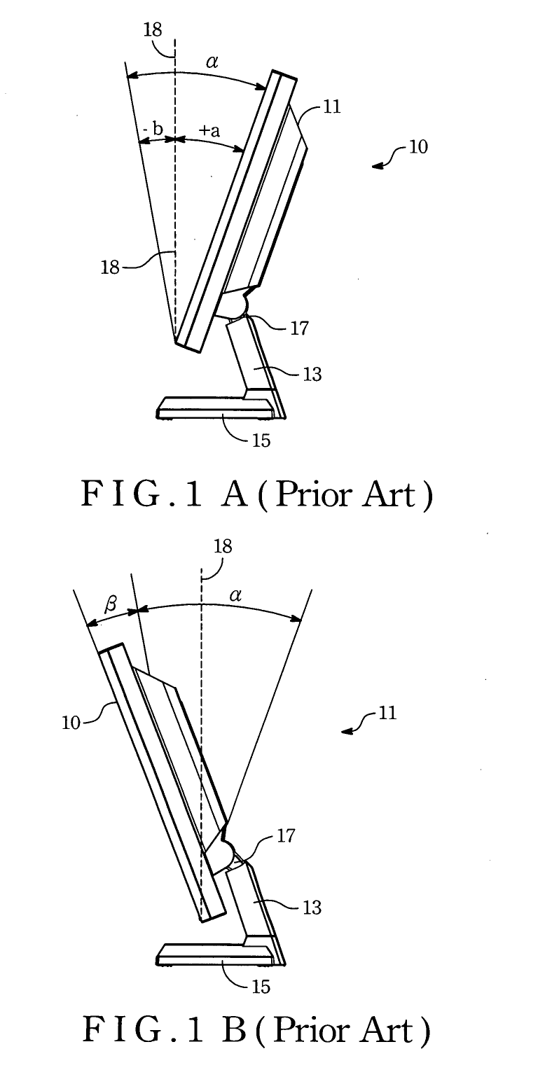

### DESCRIPTION OF THE PREFERRED EMBODIMENT

The invention disclosed herein is directed to a video display. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

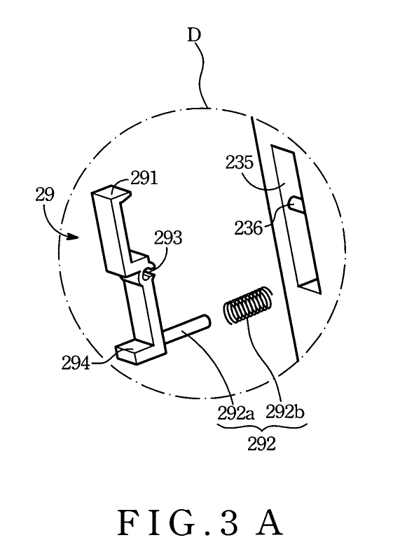

Referring now to FIG. 3 and FIG. 3A, an exploded view of a preferred video display in accordance with the present invention and an enlarged view upon circle A thereof are shown, respectively. As illustrated, the video display 20 includes a display housing 21, a support arm 23, a base 25, a pivotal mechanism 27, and a engagement mechanism 29. The display housing 21 is mounted to an upper end of the support arm 23, and the base 25 for grounding the video display 20 is mounted to a lower end of the support arm 23. The pivotal mechanism 27 joins pivotally the support arm 23 and the display housing 21 so as to pivot the display housing 21 above the support arm 23.

In the present invention, the video display 20 can be a liquid crystal display (LCD), a plasma video display (PDP), an organic light-emitting diode (OLED) display, or a surface conduction electron emitter display (SED).

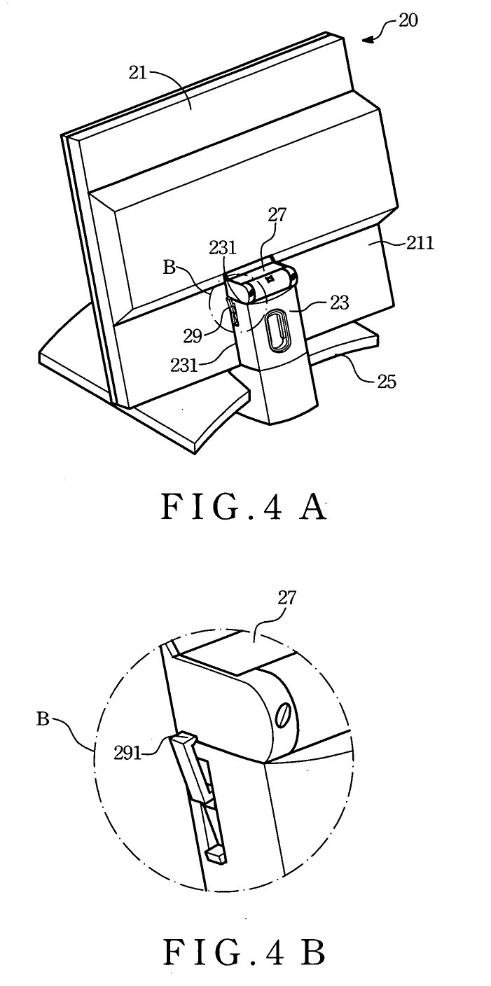

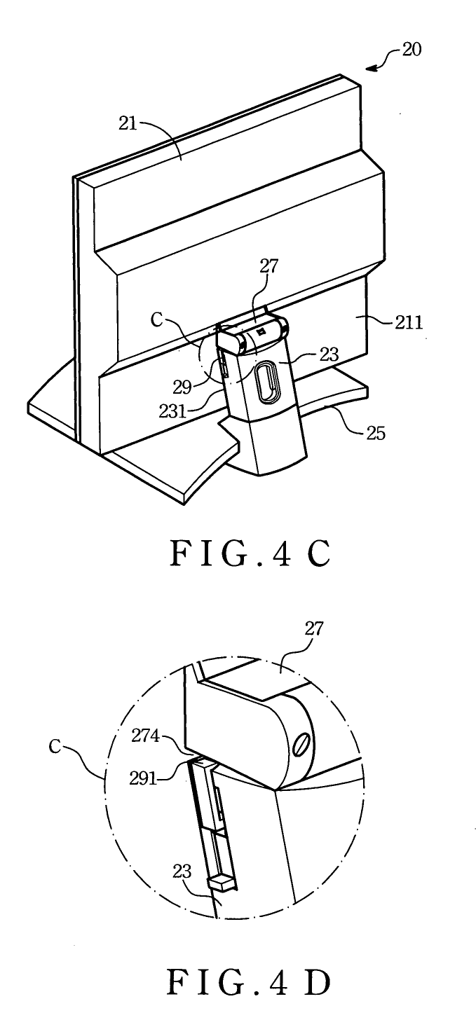

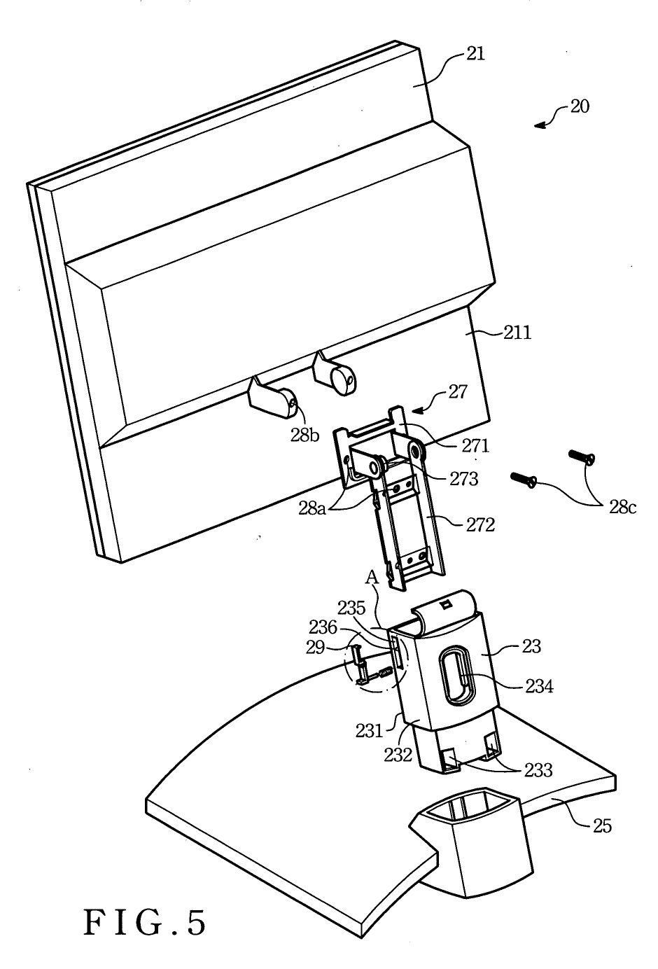

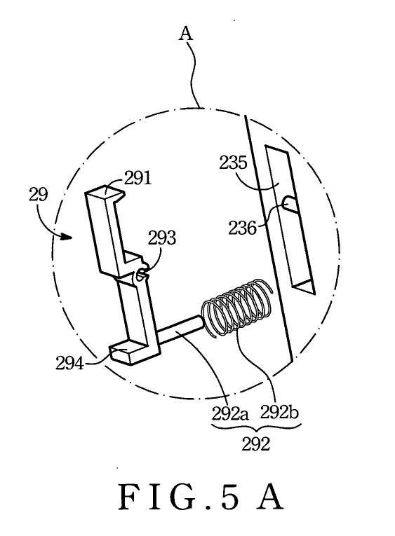

The display housing 21 can further include a back surface 211. The support arm 23 can further include a first lateral surface 231 (a front lateral surface in this embodiment) and a second lateral surface 232 adjoining the first lateral surface 231. The pivotal mechanism 27 can further include a first pivotal frame 271, a second pivotal frame 272 and a first hinge 273. Both the first pivotal frame 271 and the second pivotal frame 272 can further have respectively a plurality of holes 28a. To pair the holes 28a on the first pivotal frame 271 and the second pivotal frame 272, the back surface 211 of the display housing 21 and the first lateral surface 231 of the support arm 23 are provided also with plural screw holes 28b. By applying plural screws 28c to the holes 28a and the corresponding screw holes 28b, the first pivotal frame 271 and the second pivotal frame 272 can be fastened to the back surface 211 and the first lateral surface 23, respectively. As shown, the first hinge 273 is constructed to join pivotally the first pivotal frame 271 and the second pivotal frame 272. A pivotal spacing 274 (shown latterly in FIG. 4D) is formed between the support arm 23 and the pivotal mechanism 27.

The support arm 23 can further include a first engagement structure 233 and a separation structure 234, and the base 25 can include a second engagement structure (not shown in the figure). Generally speaking, prior to shipment of the manufacturer, the base 25 and the support arm 23 are separated so as to save package volume of the video display 20. While in assembling the base 25 and the support arm 23 at the user end, the first engagement structure 233 of the support arm 23 can engage the second engagement structure of the base 25. On the other hand, in the case that a disassembly state of the video display 20 is needed, the separation structure 234 can be applied to disengage the first engagement structure 233 and the second engagement structure so that the base 25 can be separated from the support arm 23.

In this embodiment shown by FIG. 3 and FIG. 3A, the engagement mechanism 29 of the video display 20 can include a block portion 291 at one end, an elastic means 292 at another end, and a second pivotal structure 293 in the middle thereof. The support arm 23 can further include an accommodation groove 235 constructed on the second lateral surface 232 and a first pivotal structure 236 located inside the accommodation groove 235. Preferably, the width of the open end of the accommodation groove 235 is larger than that of the opposing inside end thereof. By engaging the first pivotal structure 236 and the second pivotal structure 293, the engagement mechanism 29 can nest in the accommodation groove 235 and demonstrate a seesaw motion thereinside about the first pivotal structure 236. Preferably, the first pivotal structure 236 can be embodied as a tiny round rod, while the second pivotal structure 293 is embodied as a round slot with a c-shape cross section. The outer diameter of the first pivotal structure 236 is slightly smaller that the inner diameter of the second pivotal structure 293, such that the second pivotal structure 293 as well as the engagement mechanism 29 can turn pivotally about the first pivotal structure 236.

The elastic means 292 of the engagement mechanism 29 can further include a pin element 292a and a spring element 292b. An outer diameter of the pin element 292a is smaller that an inner diameter of the spring element 292b, such that the spring element 292b can sleeve the pin element 292a. An outer diameter of the spring element 292b is, in scale, between the width of the open end and the width of the inside end of the accommodation groove 235, such that the spring element 292b can be accommodated inside the accommodation groove 235.

Refer now to FIG. 4A to FIG. 4D. In FIG. 4A, a contact state of the back surface 211 of the display housing 21 and the first lateral surface 231 of the support arm 23 is perspective shown. In FIG. 4B, an enlarged view of circle B of FIG. 4A is shown. In FIG. 4C, a separate state of the back surface 211 of the display housing 21 and the first lateral surface 231 of the support arm 23 is perspective shown. In FIG. 4D, an enlarged view of circle C of FIG. 4C are shown, respectively. While the engagement mechanism 29 is in the contact state as shown in FIG. 4A and FIG. 4B, the block portion 291 is located outside the pivotal spacing 274. While the engagement mechanism 29 is in the separate state as shown in FIG. 4C and FIG. 4D, the engagement mechanism 29 has the block portion 291 flicked into the pivotal spacing 274 by pivoting about the first pivotal structure 236 and by the elastic forcing provided by the spring element 292b, so as to separate the back space 211 from the first lateral surface 231.

Refer back to FIG. 3 and FIG. 3A. The engagement mechanism 29 of the present invention can further include a control portion 294 constructed at the same end thereof where the elastic means 292 locates but opposed to the pin element 292a and the spring element 292b. Through the control portion 294, the block portion 291 can be easily retrieved from the pivotal spacing between the back surface 211 and the first lateral surface 231. In this separation operation, a depression can be applied to the control portion 294 as well as the spring element 292b so as to rotate the engagement mechanism 29 about the first pivotal structure 236 and to retrieve the block portion 291 from the pivotal spacing 274. Therefore, the contact state of the display housing 21 and the support arm 23 can be regained.

By providing the engagement mechanism 29 to interface inside the pivotal spacing 274 (representing the angling of the display housing 21 to the support arm 23), the display housing 21 can be maintained to be posed only within the range of allowable angular work region, so that possible falling of the video display 20 caused by accidentally rotating the display into a storage angle can thus be avoided.

It is interesting to note that the range of the pivotal spacing 274 stands for the accessible angular range of the display housing 21 with respect to the support arm 23 comprising the work angle and the storage angle. Actually, the size of the block portion 291 controls the range of the storage angle. The bigger the block portion 291 is, the larger the storage angle can be, and the smaller the work region can be obtained.

Referring now to FIG. 5 and FIG. 5A, an exploded view of another video display in accordance with the present invention and an enlarged view upon circle D thereof are shown, respectively. By comparing this embodiment to the embodiment shown in FIG. 3 and FIG. 3A, the only difference in between is at the construction of the spring element 292b of the elastic means 292 of the engagement mechanism 29. Particularly shown in FIG. 5A, the spring element 292b of this embodiment has an outer diameter larger that the open end width of the accommodation groove 235, such that, while in assembling, the spring element 292b of this embodiment is compressed to locate between the engagement mechanism 29 and the second lateral surface 232 of the support arm 23, i.e. outside the accommodation groove 235.

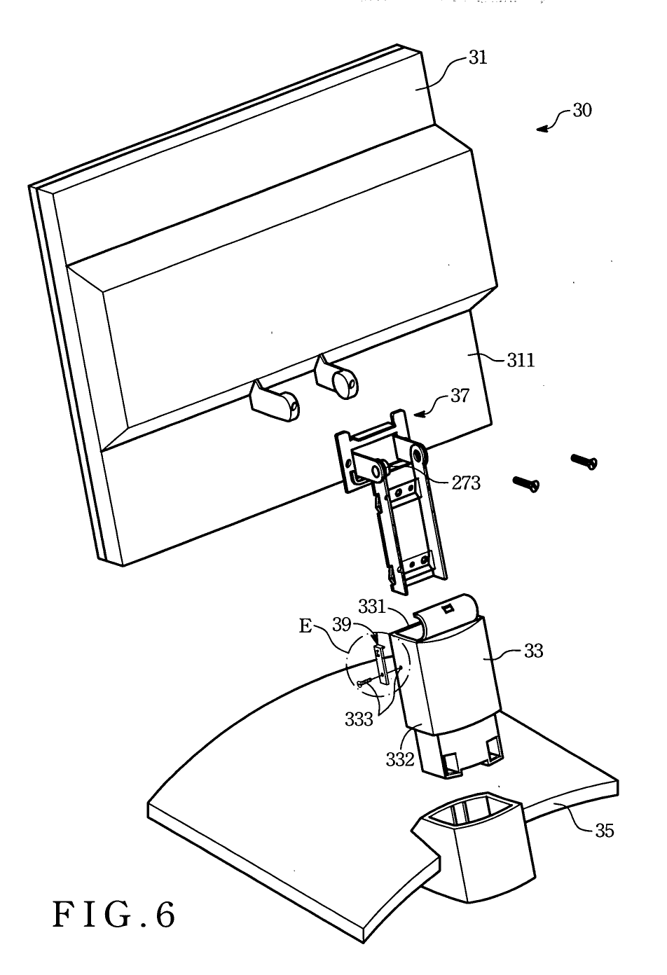

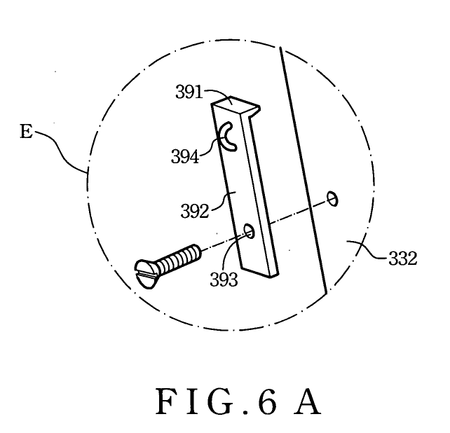

Referring now to FIG. 6 and FIG. 6A, an exploded view of a further video display in accordance with the present invention and an enlarged view upon circle E thereof are shown, respectively. As illustrated, the only difference between this embodiment and that shown in FIG. 3 is at the construction of the engagement mechanism. The engagement mechanism 39 in this embodiment includes is formed as an elastic element 392 having a block portion 391 at one end and an engagement portion 393 at another end. The engagement portion 393 is to engage a position mechanism 333 at the second lateral surface 332 of the support arm 33. In this embodiment, the position mechanism 333 includes a screw hole and a screw. By screwing the screw into the screw hole at the second lateral surface 332, the engagement portion 393 of the engagement mechanism 39 can be fixed to the support arm 33. Also, as shown in thus embodiment, the video display 30 includes the display 31, the support arm 33, the base 35, the pivotal mechanism 37 and the pivotal spacing 371, all of which are resembled to those described above in the embodiment of FIG. 3 and FIG. 3A.

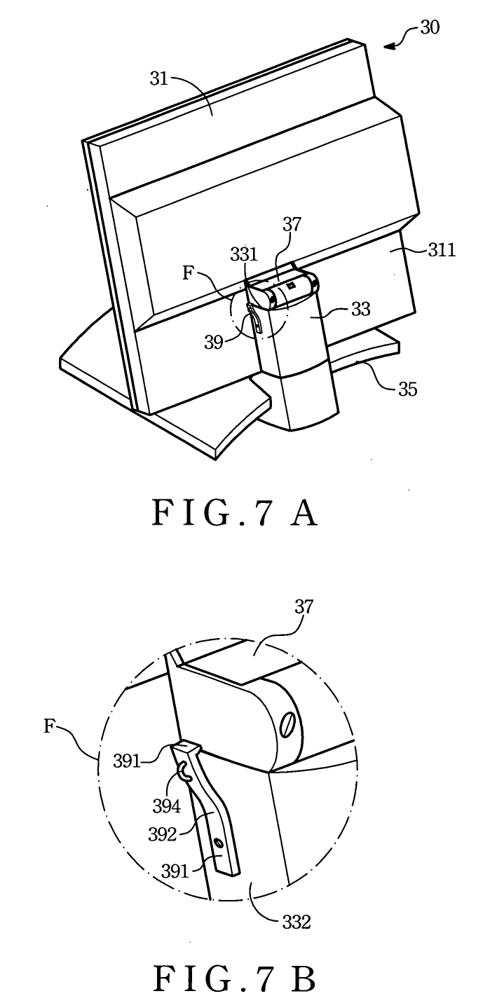

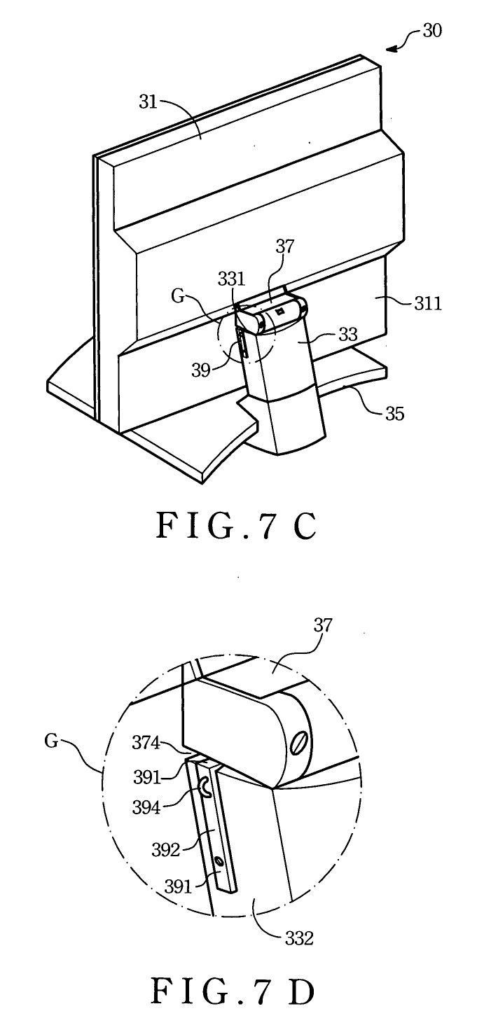

Refer now to FIG. 7A to FIG. 7D. In FIG. 7A, a contact state of the back surface 311 of the display 31 and the first lateral surface 331 of the support arm 33 is perspective shown. In FIG. 7B, an enlarged view of circle F of FIG. 7A is shown. In FIG. 7C, a separate state of the back surface 311 of the display 31 and the first lateral surface 331 of the support arm 33 is perspective shown. In FIG. 7D, an enlarged view of circle G of FIG. 7C are shown, respectively. While the engagement mechanism 39 is in the contact state as shown in FIG. 7A and FIG. 7B to have the back surface 311 of the display 31 surface-contact to the first lateral surface 331 of the support arm 33, the block portion 391 is located outside the pivotal spacing 374 by bending the elastic element 392. While the engagement mechanism 29 is in the separate state as shown in FIG. 7C and FIG. 7D to have the back surface 311 separate from the first lateral surface 331, the engagement mechanism 39 has the block portion 391 flicked into the pivotal spacing 374 by the elastic forcing provided by the pre-bent elastic element 392.

Refer back to FIG. 6. The engagement mechanism 39 of the present invention can further include a control portion 394 constructed at the same end, but opposing surface, thereof where the block portion 391 locates. By pulling the control portion 394 to bend the elastic element 392, the block portion 391 can be easily retrieved from the pivotal spacing 374 between the back surface 311 and the first lateral surface 331 (i.e., from the separate state to the contact state). At the same time of bending the elastic element 392, an elastic energy is stored in the bent elastic element 392 which would be released to flick the block portion 391 into the pivotal spacing 374 in a later time when a change from the contact state to the separate state is required.

By providing the engagement mechanism having the block portion of the present invention to the video display, the display housing can be maintained within the range of allowable angular work region only with the block portion anchored inside the pivotal spacing, so that possible falling of the video display caused by accidentally rotating the display housing into a storage angle can thus be avoided.

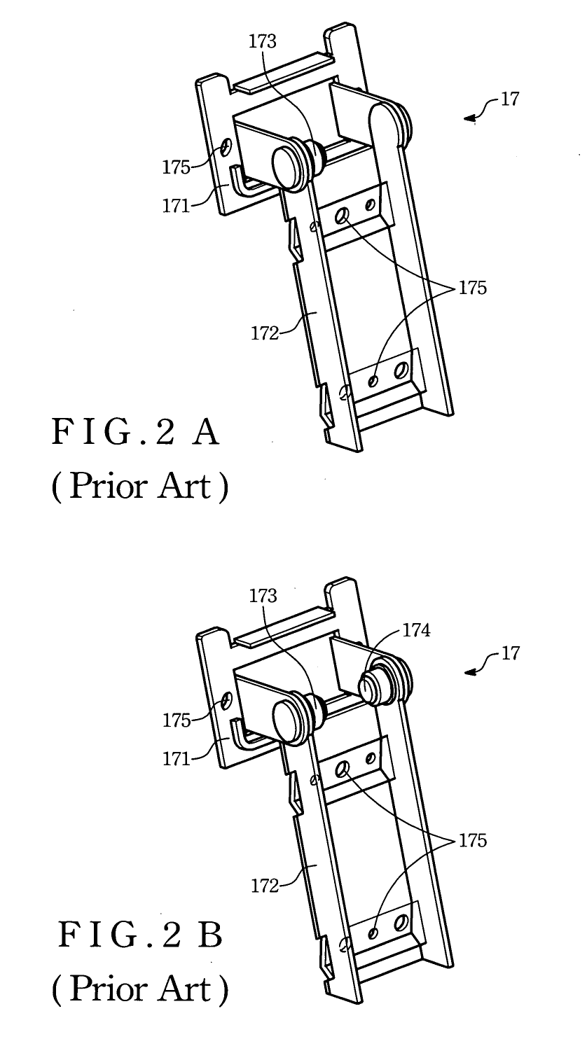

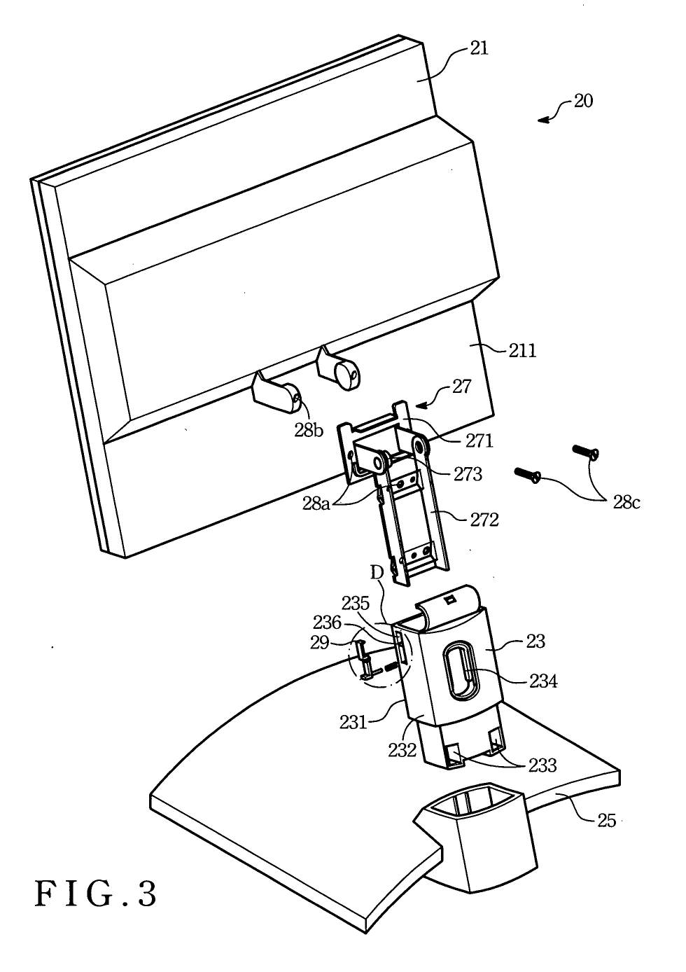

By providing the engagement mechanism of the present invention to the video display, the problem elucidated in FIG. 2A and the accompanying languages can be easily resolved, and the additional cost and application forcing arisen from introducing the second hinge elucidated in FIG. 2B and the accompanying languages can also be avoided.

While the present invention has been particularly shown and described with reference to a preferred embodiment, it will be understood by those skilled in the art that various changes in form and detail may be without departing from the spirit and scope of the present invention.

I claim:

1. A video display, comprising:
a display housing;
a support arm having a first lateral surface, a second lateral surface, an accommodation groove formed on the second lateral surface, and a first pivotal structure disposed within the accommodation groove;
a pivotal mechanism connecting the support arm and the display housing, and forming a pivotal spacing between the display housing and the support arm; and
an engagement mechanism having a block portion, an elastic means, and a second pivotal structure, the engagement mechanism partially disposed within the accommodation groove, and the second pivotal structure engaged pivotally with the first pivotal structure;
wherein, when the block portion is disposed outside the pivotal spacing, the display housing is separated from the first lateral surface by a first distance;
wherein, when the block portion is disposed within the pivotal spacing, the display housing is contacted by the block portion and separated from the first lateral surface by a second distance, and the second distance is longer than the first distance.

2. The video display according to claim 1, wherein said first distance is zero, such that said displaying housing contacts said first lateral surface when said block portion is disposed outside said pivotal spacing

3. The video display according to claim 1, wherein said first lateral surface is a front lateral surface of said support arm, and a tilt angle of said display housing is adjusted by changing a distance between said display housing and said first lateral surface.

4. The video display according to claim 1, wherein said first pivotal structure is formed as a tiny round rod, and said second pivotal structure is formed as a round slot with a c-shape cross section.

5. The video display according to claim 1, wherein said elastic means further includes a pin element and a spring element, in which the spring element sleeving the pin element is accommodated inside said accommodation groove.

6. The video display according to claim 5, wherein said engagement mechanism further includes a control portion constructed at the same end thereof where said elastic means locates but opposed to said pin element and said spring element.

7. A video display, comprising:
a display housing;
a support arm having a first lateral surface;
a pivotal mechanism, pivotally connecting the support arm and the display housing, and forming a pivotal spacing between the display and the support arm; and
a block portion for selectively plugged into the pivotal spacing;
wherein, when the block portion is disposed outside the pivotal spacing, the display housing is separated from the first lateral surface by a first distance;
wherein, when the block portion is disposed within the pivotal spacing, the display housing is contacted by the block portion and separated from the first lateral surface by a second distance, and the second distance is longer than the first distance.

8. The video display according to claim 7, wherein said first distance is zero, such that said displaying housing contacts said first lateral surface when said block portion is disposed outside said pivotal spacing.

9. The video display according to claim 7, wherein said first lateral surface is a front lateral surface of said support arm, and a tilt angle of said display housing is adjusted by changing a distance between said display housing and said first lateral surface.

10. The video display according to claim 9, wherein said support arm further comprises:
a second lateral surface, adjoining said first lateral surface;
an accommodation groove formed on the second lateral surface;
a first pivotal structure located inside the accommodation groove; and
an engagement mechanism, connected to said block portion, having an elastic means and a second pivotal structure pivotally connected with said first pivotal structure;
wherein, when said display housing is rotated away from said first lateral surface, said block portion is flicked into said pivotal spacing by an elastic force provided by the elastic means.

11. The video display according to claim 10, wherein said first pivotal structure is formed as a tiny round rod, and said second pivotal structure is formed as a round slot with a c-shape cross section.

12. The video display according to claim 10, wherein said elastic means further comprises a pin element and a spring element, in which the spring element sleeving the pin element is accommodated inside said accommodation groove.

13. The video display according to claim 12, wherein said engagement mechanism further comprises a control portion constructed at the same end thereof where said elastic means locates but opposed to said pin element and said spring element.

14. The video display according to claim 7, further comprising:
an elastic engagement mechanism connected to said block portion at a first end, the elastic engagement mechanism having an engagement portion at a second end, the engagement portion fixed onto said second lateral surface;
wherein the elastic engagement mechanism is bent by said display housing when said block portion is disposed outside said pivotal spacing;
wherein, when said display housing is rotated away from said first lateral surface, said block portion is flicked into said pivotal spacing by an elastic force provided by the elastic engagement mechanism.

15. The video display according to claim 14, wherein said engagement mechanism further comprises a control portion constructed at the same end connected to said block portion, the control portion remained outside said pivotal spacing when said block portion is located within said pivotal spacing.

16. The video display according to claim 7, further comprising a spring element connected to one of said support arm and said pivotal mechanism, the spring element pushing said block portion to a direction toward said pivotal spacing.

17. A video display, comprising:
a display housing;
a support arm;
a pivotal mechanism, pivotally connecting the support arm and the display housing, further having a pivotal spacing formed between the display housing and the support arm; and
a block portion for selectively plugged into the pivotal spacing;
wherein, when the block portion is disposed outside the pivotal spacing, the display housing is rotatable for a first angle;
wherein, when the block portion is disposed within the pivotal spacing, the display housing is contacted by the block portion and rotatable for a second angle, and the second angle is smaller than the first angle.

18. The video display according to claim 17, further comprising a spring element connected to one of said support arm and said pivotal mechanism, the spring element pushing said block portion to a direction toward said pivotal spacing.

19. The video display according to claim 17, wherein said first lateral surface is a front lateral surface of said support arm, and a tilt angle of said display housing is adjusted by plugging said block portion into said pivotal spacing.

20. The video display according to claim 17, wherein said first angle allows said display housing to rotate to contact said first lateral surface when said block portion is disposed outside said pivotal spacing.
